(19) United States
(12) Patent Application Publication
(10) Pub. No.: US 2011/0139667 A1
(43) Pub. Date: Jun. 16, 2011

(54) Stackable Suction Canister and Lid Assembly

(76) Inventors: James E. Burgess, Mundelein, IL (US); John Kutsch, Harvard, IL (US)

(21) Appl. No.: 12/769,900

(22) Filed: Apr. 29, 2010

Related U.S. Application Data
(60) Provisional application No. 61/285,581, filed on Dec. 11, 2009.

(51) Int. Cl. B65D 21/02; B65G 57/00

(52) U.S. Cl. 206/515; 414/802

(57) ABSTRACT

A stackable lid (100) and corresponding fluid collection canister (500,600) are provided. The stackable lid (100) has a lid member (101) that defines a first partial lid interior portion (201) and a second partial lid interior portion (202). One or more ports (107,108,109) are disposed on the first partial lid interior portion (201), with a filter engagement extension (301) extending beneath one of the ports. A stacking recess (211) is disposed on the second partial lid interior portion (202), and can be out of phase relative to the filter engagement extension (301). When lids are stacked correspondingly out of phase, a filter (902) coupled to the filter engagement extension (301) nests within the stacking recess (211), thereby reducing overall stack height by sixty percent or more.

### CROSS REFERENCE TO PRIOR APPLICATIONS

This application claims priority and benefit under 35 U.S.C. §119(e) from U.S. Provisional Application No. 61/285,581, filed Dec. 11, 2009.

### BACKGROUND

1. Technical Field

This invention relates generally to fluid collection containers and accompanying lids, and more particularly to stackable fluid collection containers and stackable lids.

2. Background Art

Medical professionals, such as surgeons, use vacuum-like devices to remove excess fluids during medical procedures. For example, during a surgical procedure, a surgeon will couple a suction device to a fluid collection container by way of a flexible tube. The suction device draws unwanted fluids from the surgical site into the container. A coagulant can then be added to the fluid to transform it to a solid or semi-solid for disposal. Fluid collection containers are used to collect and dispose of fluids in a variety of medical procedures.

Prior art containers include open-top buckets and snap-on lids. A problem with these prior art containers is that they are not readily stackable. They are further cumbersome to store. They are also bulky and not readily packable for shipping from manufacturer to end user.

There is thus a need for an improved fluid collection container and lid that is more readily stackable.

### BRIEF DESCRIPTION OF THE DRAWINGS

FIG. 1 illustrates a top, left, front, perspective view of one lid for a fluid collection container in accordance with embodiments of the invention.

FIG. 2 illustrates a top, plan view of a fluid collection container in accordance with embodiments of the invention.

FIG. 3 illustrates a bottom, right, rear, perspective view of one lid for a fluid collection container in accordance with embodiments of the invention.

FIG. 4 illustrates a bottom, plan view of one lid for a fluid collection container in accordance with embodiments of the invention.

FIG. 5 illustrates a perspective view of one fluid collection container in accordance with embodiments of the invention.

FIG. 6 illustrates a perspective view of another fluid collection container in accordance with embodiments of the invention.

FIG. 7 illustrates a perspective view of one embodiment of a lid connected to one embodiment of a fluid collection container in accordance with embodiments of the invention.

FIG. 8 illustrates a side elevation view of one embodiment of a lid connected to one embodiment of a fluid collection container in accordance with embodiments of the invention.

FIG. 9 illustrates a sectional view of a plurality of lids stacked together, with each lid out of phase, in accordance with embodiments of the invention.

FIG. 10 illustrates a method for stacking canisters and lids with the assistance of one or more automated stacking machines in accordance with embodiments of the invention.

FIG. 11 illustrates an exemplary per case stacking structure for lids and canisters in accordance with embodiments of the invention.

FIG. 12 illustrates a pallet having cases of stacked lids and canisters in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention include a canister or fluid collection container for capturing fluids from medical processes and an accompanying lid that is suitable for coupling to a vacuum or other fluid suction apparatus. Embodiments of the present invention offer advantages over the prior art in that the design of the lid provides a sixty percent or more reduction in stack height when compared to prior art designs. This reduction in stacked height translates to increased shipping efficiency, as more canisters and lids can be shipped on a pallet than with prior art designs. By way of example, when lids in accordance with embodiments of the invention are used with 1500 cc canisters, embodiments of the present invention allow as many as three times the number of prior art canisters to be shipped on a standard pallet.

In one embodiment, the lid includes a plurality of ports. By way of example, one port can be coupled to a fluid suction device, while another can be connected to a suction apparatus that captures the fluids to be collected. In one embodiment, the canisters are configured so as to be connectable in a daisy chain configuration to capture more liquid. In such an embodiment, an auxiliary port facilitates coupling the various canisters together.

In one embodiment, the ports are all disposed on one side of the top of a lid, with a recess and planar ledge being disposed on the other side. As such, when the lids are rotated 180 degrees out of phase, the asymmetrical configuration facilitates a reduced stacking height.

Lids in accordance with the invention are configured to connect to a canister. In one embodiment, the canister comprises a cylindrical container with tapered sides. The amount of taper and size of the canister are configured to stack and fit into a case that will, in one embodiment, be shipped to an end user or wholesaler on a 40″×48″ pallet.

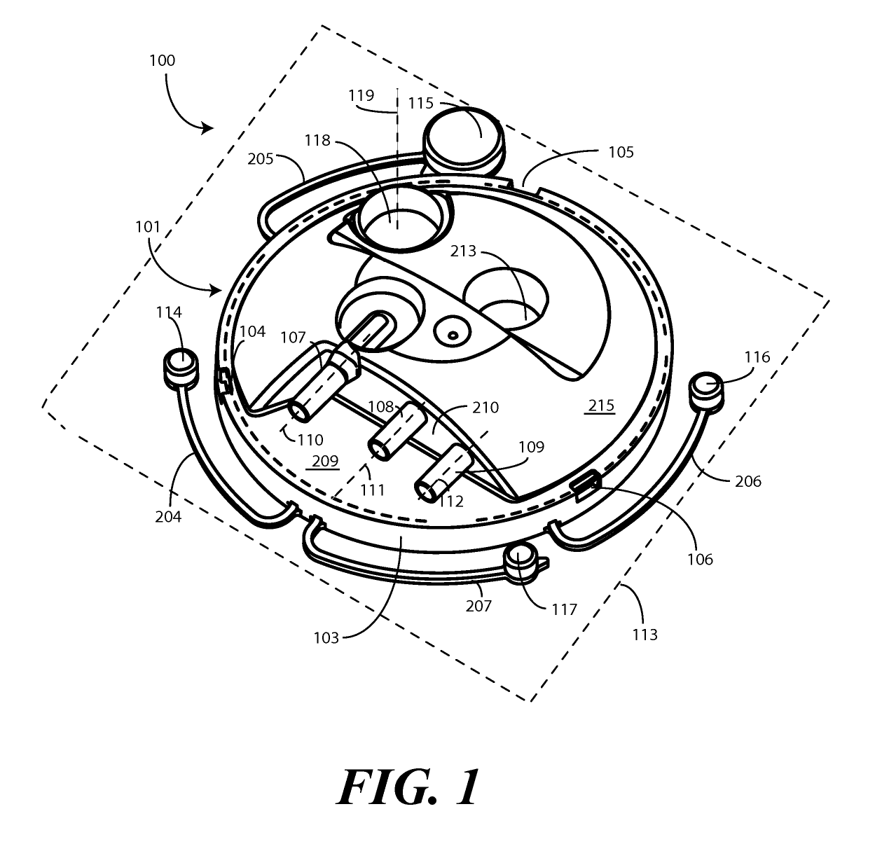

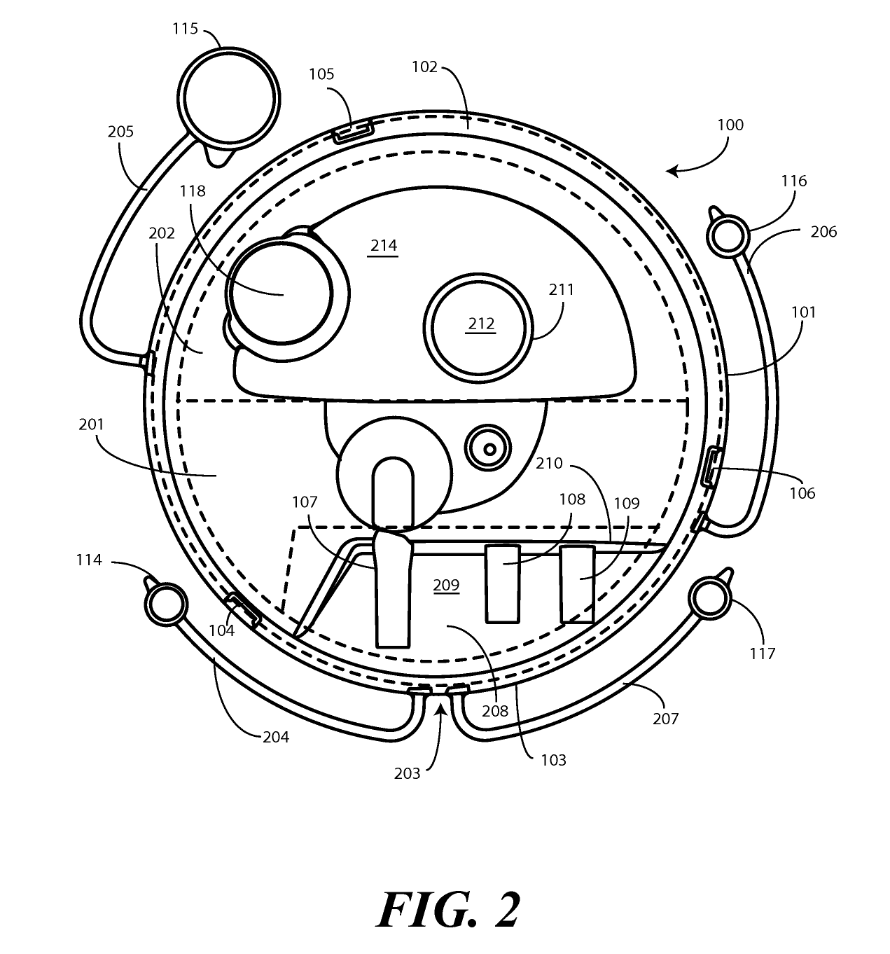

Turning now to FIGS. 1 and 2, illustrated therein are a perspective view and a plan view, respectively, of one embodiment of a stackable lid 100 for a fluid collection canister in accordance with embodiments of the invention. When the stackable lid 100 is coupled to a canister, the assembly can be used with a vacuum or suction apparatus for collecting fluids from a fluid collection device in a medical procedure.

In the illustrative embodiment of FIGS. 1 and 2, the stackable lid 100 includes a lid member 101 that can be manufactured from a thermoplastic material by way of an injection molding process. For example, in one embodiment, the stackable lid 100 is manufactured from polypropylene. In another embodiment, the stackable lid 100 is manufactured from polyethylene. It will be obvious to those of ordinary skill in the art having the benefit of this disclosure that other suitable semi-rigid materials may be substituted for the thermoplastic. Further, other manufacturing processes may be used to fabricate the stackable lid 100.

The lid member 101 includes an interior portion 102 and a perimeter portion 103. The interior portion 102, in one embodiment, is a contoured, circular member that is surrounded by, and that is oriented substantially orthogonally with, the perimeter portion 103. In one embodiment, the perimeter portion 103 comprises a substantially circular (when viewed in plan view) sidewall surrounding the interior portion 102. The perimeter portion 103 works as a “canister connector” in that it is configured to connect to a fluid collection canister. In one embodiment, perimeter portion 103 can have one or more compliant coupling members 104,105,106 disposed therealong. In the illustrative embodiment of FIG. 1, the compliant coupling members 104,105,106 are configured as cantilever members extending from the lid member 101 so as to “clamp” the edge of a fluid collection canister against the perimeter portion 103.

In the illustrative embodiment of FIGS. 1 and 2, the interior portion 102 of the stackable lid 100 can be viewed for reference as being divided into to partial portions. Specifically, as seen in FIG. 2, the interior portion 102 includes a first partial lid interior portion 201 and a second partial lid interior portion 202. The ratios of area between the first partial lid interior portion 201 and the second partial lid interior portion 202 need not be equal, although in some embodiments they may be. In other embodiments, one or the other will be greater. For example, in one embodiment, the first partial lid interior portion 201 may occupy sixty percent of the interior portion 102, while the second partial lid interior portion 202 occupies forty percent, or vice versa. In another embodiment, the first partial lid interior portion 201 may occupy seventy percent of the interior portion 102, while the second partial lid interior portion 202 occupies thirty percent, or vice versa, and so forth.

In one stackable embodiment, the first partial lid interior portion 201 will occupy substantially fifty percent of the interior portion 102, while the second partial lid interior portion 202 occupies substantially fifty percent as well. As will be described below, in one embodiment a reduced stacking height is obtained by stacking successive lids with an orientation that is 180 degrees out of phase with adjacent lids. In such an embodiment, the first partial lid interior portion 201 and second partial lid interior portion 202 will be roughly equal. They may differ by a few percentage points, however, without deviating from the scope of the invention.

The stackable lid 100 is configured to connect to, and essentially seal the opening of, a canister. Embodiments of the canister will be shown in subsequent figures. In one embodiment, the stackable lid 100 includes a plurality of ports 107,108,109 for collecting and transporting fluids. For instance, the exemplary embodiment of FIGS. 1 and 2 includes three ports.

To facilitate reduced height stackability, in one embodiment all of the plurality of ports 107,108,109 are disposed on one partial interior portion. For example, in the illustrative embodiment of FIGS. 1 and 2, all of the plurality of ports are disposed along the first partial lid interior portion 201, with no ports residing in the second partial lid interior portion 202.

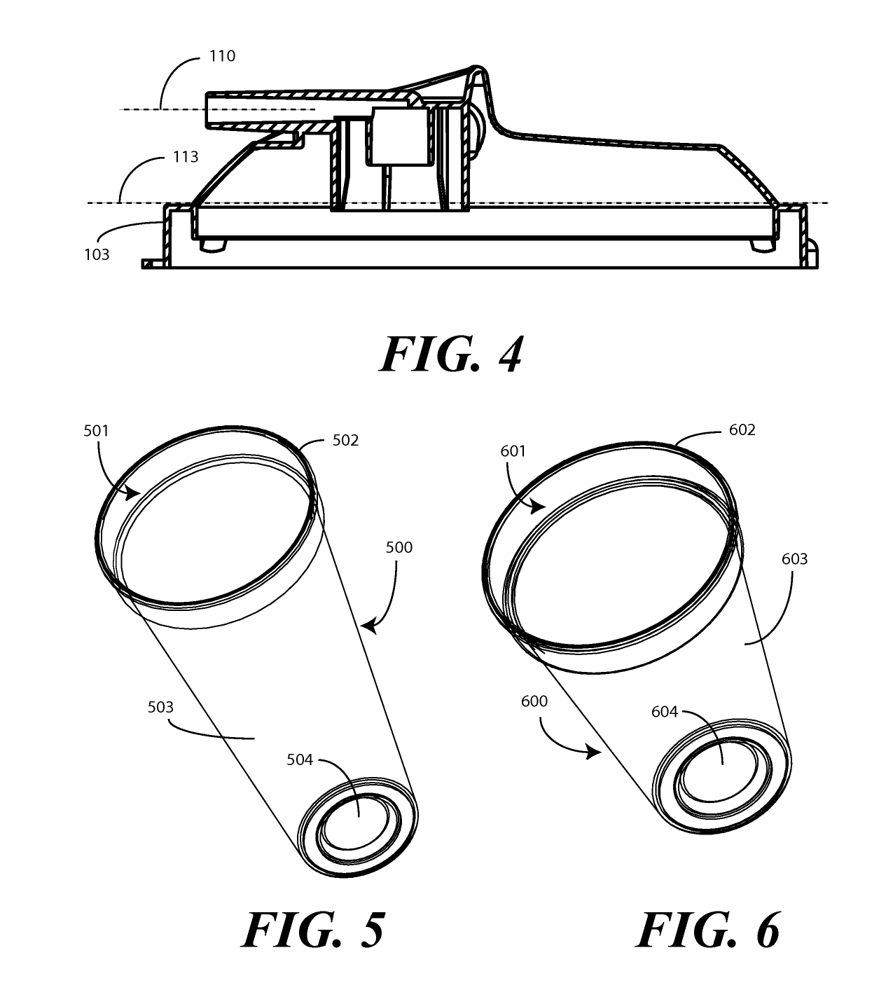

In the illustrative embodiment of FIGS. 1 and 2, each of the plurality of ports 107,108,109 extends from the first partial lid interior portion 201 towards the perimeter portion 103 of the lid member 101. To further increase stackability, each of the plurality of ports 107,108,109 in this illustrative embodiment has been turned sideways, such that a reference axis 110,111,112 running through each of the plurality of ports 107,108,109 is aligned substantially parallel with a plane 113 defined by the perimeter portion 103. Said differently, each of the plurality of ports 107,108,109 is turned sideways so as to be parallel with a major surface of the interior portion 102 of the lid member 101. This can best be seen by briefly turning to FIG. 4, where a reference axis 110 of the vacuum port is shown substantially parallel with the plane 113 defined by the perimeter portion 103.

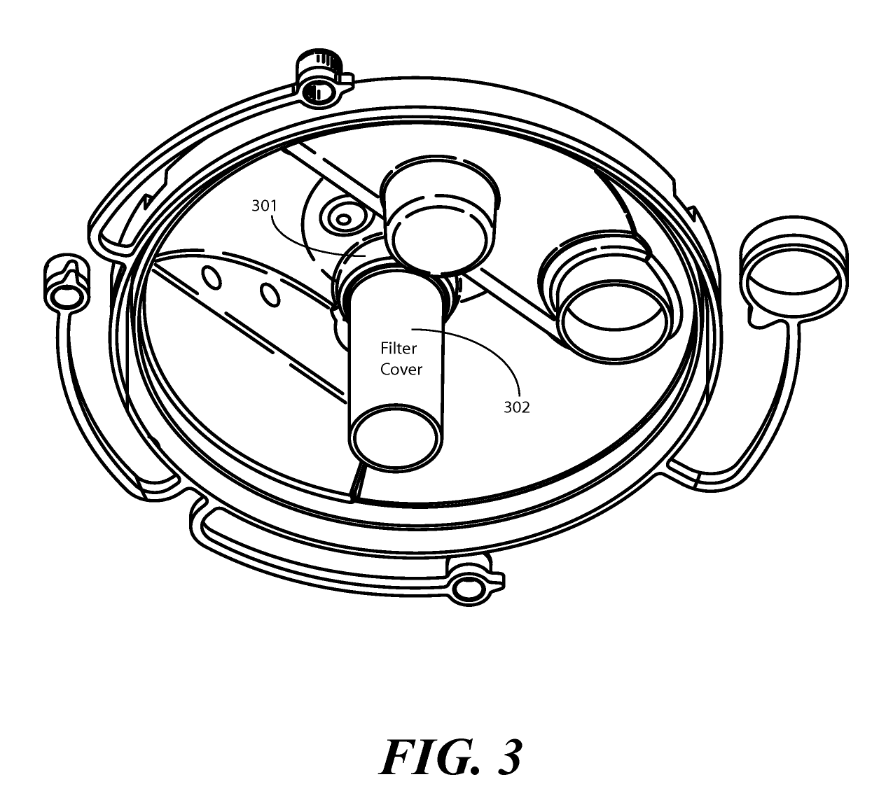

In the illustrative embodiments of FIGS. 1 and 2, each of the plurality of ports 107,108,109 has a length that remains within a lid perimeter 203 defined by the perimeter portion 103. Said differently, each of the plurality of ports 107,108,109 has a length that extends from the first partial lid interior portion 201 towards the perimeter portion 103, but stays within a perimeter defined by the perimeter portion 103. As viewed in FIG. 3, the length of each of the plurality of ports 107,108,109 stays within the plan view of the stackable lid 100, and does not hang over the perimeter portion 103. As such, when lids are stacked on top of each other, the perimeter portion 103 does not interfere with any of the plurality of ports 107,108,109.

The plurality of ports 107,108,109 facilitates fluid collection and transport to and from the fluid collection container. While the ports can be arranged in any number of ways, and can accommodate any number of functions, in one embodiment the plurality of ports 107,108,109 includes a vacuum port, a patient port, and a “tandem” port. In the illustrative embodiment of FIGS. 1 and 2, port 107 is configured as a vacuum port, while port 108 is configured as a patient port. Port 109 is configured as the tandem port.

A vacuum or other suction appliance is coupled to the vacuum port via tubing. Another suction tubing can then be coupled to the patient port. This suction tubing is then coupled to a hand-held suction device. When the vacuum or suction appliance is actuated, the vacuum draws fluid through the hand-held suction device into the patient port and into the fluid collection container. Fluid is prevented from entering the vacuum or suction device by way of a filter placed beneath the vacuum port, as will be described in FIG. 3. Further, an optional filter cover can be disposed about the filter to protect the filter from incoming fluids. Note that for optimum draw, where ports are not being used, they can be sealed with one of the one or more caps 114,115,116,117 that are integrally coupled, in this illustrative embodiment, to the stackable lid 100 by a corresponding tab 204,205,206,207. In the illustrative embodiment of FIGS. 1 and 2, each tab 204,205,206,207 extends substantially orthogonally (as viewed in FIG. 1) from the perimeter portion 103.

The tandem port can be used to daisy chain fluid collection canisters together. For example, in some medical procedures, it will be anticipated that more fluid will be collected than can be stored in a single fluid collection container. In such situations, it may be necessary to couple multiple fluid collection canisters together with the tandem port, such that when one gets full, fluid can be delivered to other, empty fluid collection canisters.

In addition to the plurality of ports 107,108,109, in one embodiment a pour spout 118 is included. In the illustrative embodiment of FIGS. 1 and 2, the second partial lid interior portion 201 includes the pour spout 118. The pour spout 118 is typically used for pouring solidifier into a filled canister after drawing fluids into the canister. The solidifier agglutinates the fluid, thereby making it easy to transport or dispose. While fluid is being drawn into the container, the pour spout 118 will generally be covered with one of the caps, e.g., cap 115.

In one embodiment, the pour spout 118 is oriented differently than are each of the plurality of ports 107,108,109. For example, in one embodiment, a pour spout axis 119 is oriented substantially orthogonally relative to the axes 110,111,112 of each of the plurality of ports 107,108,109, as can be seen in FIGS. 1 and 2. This orientation of the pour spout 118 facilitates simplified addition of the solidifier to the fluid collection container.

Some of the ports can be configured to extend from the interior portion 102 differently than do others. For example, in the illustrative embodiment of FIGS. 1 and 2, the first partial lid interior portion 201 includes approximately a half-quadrant 208 of the interior portion 102 that has a planar interior member 209 and a port support wall 210. In this illustrative embodiment, the port support wall 210 extends substantially orthogonally from the planar interior member 209 and supports the three ports, which each extend substantially orthogonally from the port support wall towards the perimeter portion 103. This configuration assists an operator in quickly identifying the function of the various ports.

Turning briefly to FIG. 3, illustrated therein is a bottom view of one stackable lid 100 in accordance with embodiments of the invention. As noted above, a suction tube can be coupled to the vacuum port to facilitate fluids being drawn into the fluid collection container. In some applications, it can be desirable to prevent fluids from entering the vacuum. This can be accomplished by attaching a filter between the vacuum device and the fluid collection container. As further protection, the filter can be covered with a protective sleeve 302. In the illustrative embodiment of FIG. 3, attachment of both the filter and/or protective sleeve 302 can be accomplished with the use of a filter engagement extension 301 that extends from the bottom side of the first partial lid interior portion beneath one of the ports.

In FIG. 3, the filter engagement extension 301 is configured to be substantially a cylinder that extends beneath the vacuum port. The filter engagement extension 301 can also include one or more filter engagement devices extending therefrom that are configured to retain a suitable filter within the filter engagement extension 301. Engagement devices may also be provided for coupling to the protective sleeve 302.

Turning now back to FIGS. 1 and 2, in this illustrative embodiment, to facilitate a reduced stacking height, the second partial lid interior portion 202 includes a stacking recess 211. The stacking recess 211, in one embodiment, is substantially cylindrical, although other shapes can be substituted depending upon the filter type used with the stackable lid 100, and/or whether a protective sleeve is disposed about the filter. In one embodiment, the stacking recess 211 includes a floor 212 and a sidewall 213, which may be tapered as the sidewall 213 extends from the lid member 101 to the floor 212. The stacking recess 211 is configured to receive a filter or protective sleeve coupled to an adjacent lid when the lids are rotated out of phase and stacked. In the illustrative embodiment of FIGS. 1 and 2, the stacking recess 211 is disposed 180 degrees out of phase with respect to one of the plurality of ports 107,108,109. For example, as can be seen in FIG. 2, the stacking recess 211 is 180 degrees out of phase relative to port 107.

When a filter and/or protective sleeve is attached to the filter engagement extension 301 of an adjacent lid, and that adjacent lid is rotated 180 degrees out of phase and is stacked on another lid, the filter and/or protective sleeve can sit within the stacking recess 211. This configuration works in practice to reduce the overall stacking height by roughly sixty percent when compared to prior art lid designs.

In one embodiment, the second partial lid interior portion 202 further includes a substantially planar, semi-circular ledge 214 that is disposed about the stacking recess 211. While the semi-circular ledge 214 is semi-circular in FIGS. 1 and 2, it will be clear to those of ordinary skill in the art that it may have other shapes as well without departing from the spirit and scope of the invention. An arching sidewall 215 then extends from the semi-circular ledge 214 toward the perimeter portion 103.

Turning now to FIGS. 5 and 6, illustrated therein are exemplary embodiments of fluid collection canisters 500,600 suitable for use with the invention. The difference between each fluid collection canister 500,600 in these illustrative embodiments is the size. Fluid collection canister 500 is a 2400 cc canister, while fluid collection canister 600 is a 1500 cc canister. These sizes are exemplary only, and embodiments of the invention are not intended to be limited in this regard, as any of canisters suitable for use with the invention can be created in a wide variety of sizes.

In one embodiment, the fluid collection canisters 500,600 are manufactured from a clear, substantially rigid thermoplastic by way of an injection molding process. For example, the fluid collection canisters can be manufactured from clear polystyrene, which is also known sometimes by the name “crystal styrene.”

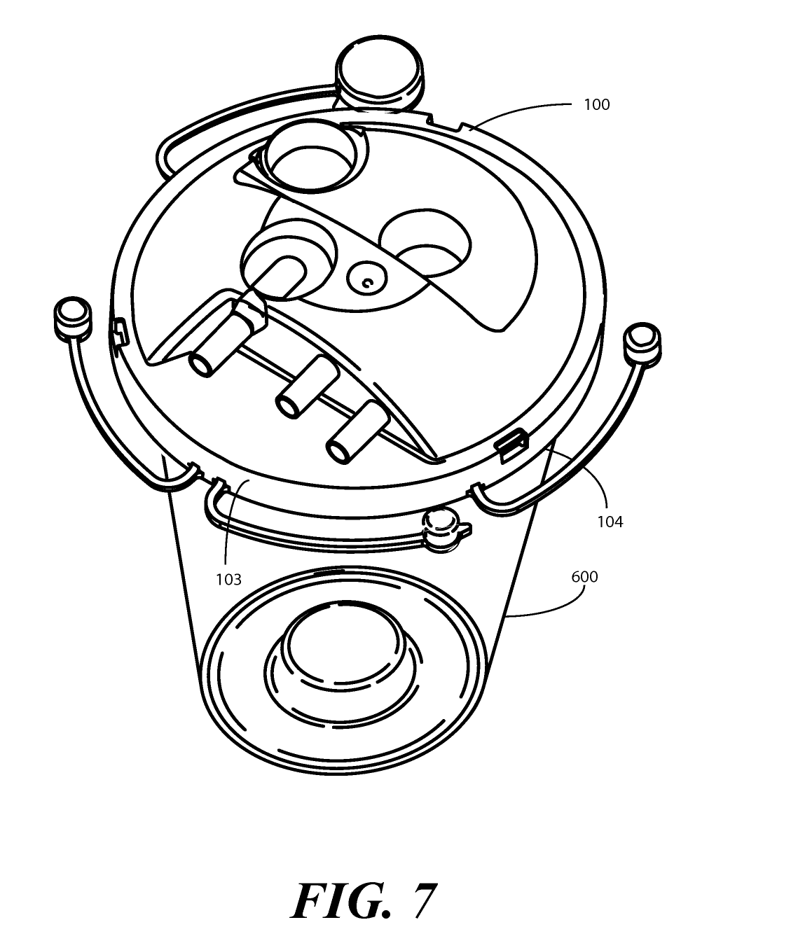

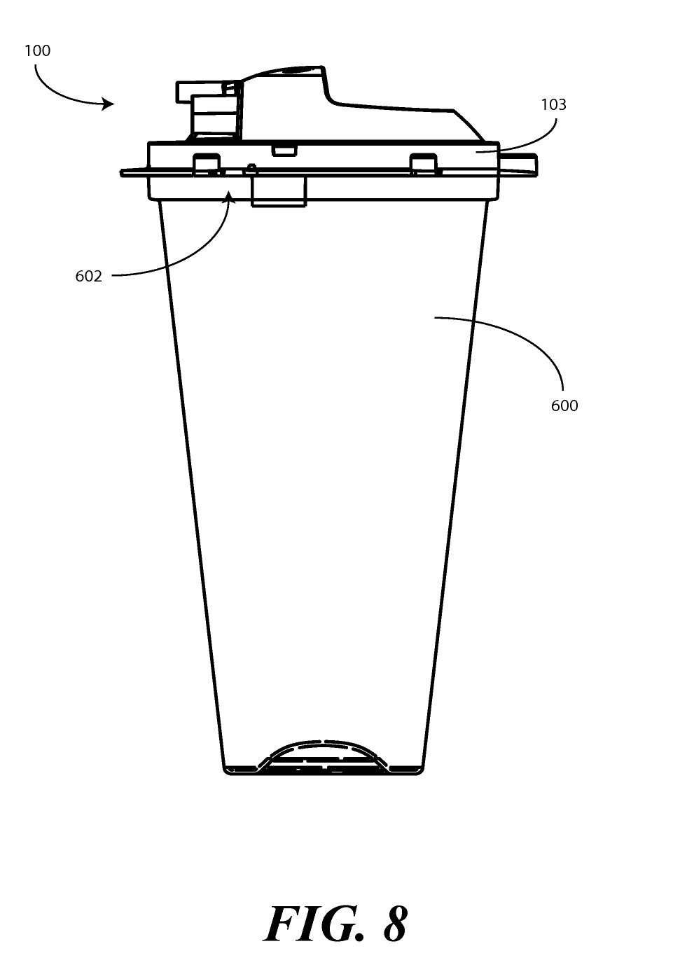

In one embodiment, each fluid collection canister 500,600 includes a rim 501,601, which may include a lip 502,602 or other mating feature that is suitable for coupling to or otherwise engaging a lid. The fluid collection canisters 500,600 can include tapered sidewalls 503,603 that extend distally from the rim 501,601 to a base member 504,604, which may be reinforced. Tapered sidewalls 503,603 help facilitate release of the fluid collection canisters 500,600 both from stacked configurations with other canisters and from a mold, where the canisters are manufactured by injection molding. Turning to FIG. 8, illustrated therein is one embodiment of a stackable lid 100 coupled to a fluid collection canister 600 in accordance with embodiments of the invention. As shown in FIGS. 7 and 8, the perimeter portion 103 of the stackable lid 100 has been connected to the lid-engaging rim 602. The stackable lid 100 is held in a connected configuration with the fluid collection canister 600 with the assistance of one or more compliant coupling members, e.g., compliant coupling member 104.

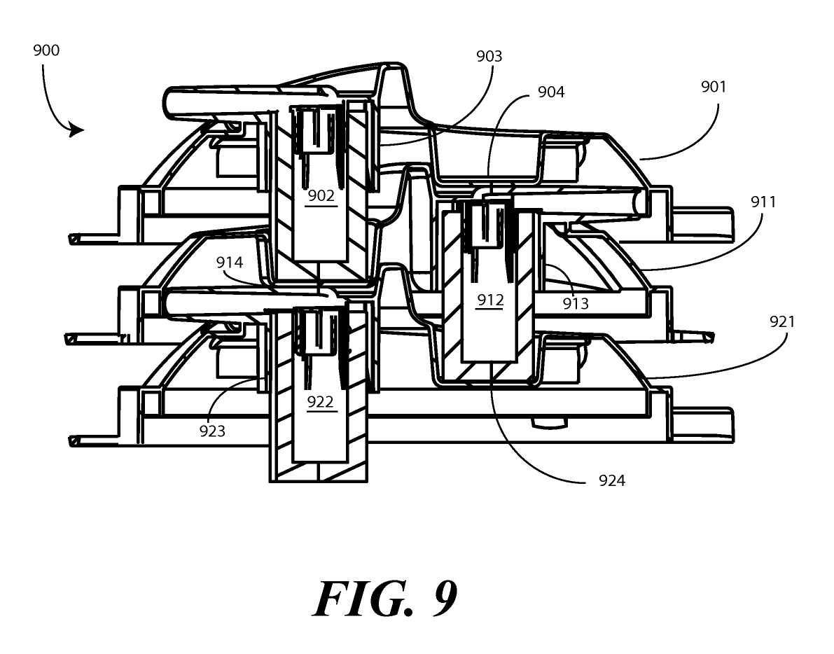

Turning now to FIG. 9, illustrated therein is an exemplary stack 900 of stackable lids 901,911,921 in accordance with embodiments of the invention. As seen in FIG. 9, each of the stackable lids 901,911,921 includes a filter-protecting sleeve 902,912,922 coupled thereto. In this illustrative embodiment, filter-protecting sleeve 902 is coupled to a filter-sleeve coupling member 903 extending from the bottom side of the interior portion of the first lid 901 beneath one of the ports, while filter-protecting sleeve 912 is similarly coupled to a filter-sleeve coupling member 913 of the second lid 911. Filter-protecting sleeve 922 is likewise coupled to a filter-sleeve coupling member 923 of the third lid 923.

To facilitate a reduced stacking height, each lid 901,911,921 includes substantially cylindrical recess (due to the illustrative filter-protecting sleeves (902,912,922) having a cylindrical cross section) disposed 180 degrees out of phase relative to one of the plurality of ports. As shown in FIG. 9, lid 901 includes cylindrical recess 904, while lid 911 includes cylindrical recess 914. Similarly, lid 921 includes cylindrical recess 924. Note that the recesses need not be cylindrical, they merely need to coincide with the cross-sectional shape of the filter and/or protecting sleeve that is attached, where the filter and/or sleeve is intended to sit within the recess.

When stacked, each lid is rotated out of phase with each other. As shown in FIG. 9, lid 901 has its filter-protecting sleeve 902 on the left, while lid 911 has its filter-protecting sleeve 912 on the right. This is accomplished by rotating lid 911 180 degrees out of phase relative to lid 901. Lid 921 is then aligned with lid 901, which is also 180 degrees out of phase with lid 911. Note that the lids in this illustrative embodiment are rotated 180 degrees out of phase with each other due to the number and configuration of ports. However, it will be obvious to one of ordinary skill in the art having the benefit of this disclosure that the invention is not so limited. In some applications, a similar stacking configuration may be obtained by rotating the lids sixty degrees out of phase, ninety degrees out of phase, 120 degrees out of phase, and so forth. When each lid is rotated out of phase, its corresponding filter and/or protecting sleeve sits within the recess of an adjacent lid, as shown, to reduce the overall stacking height.

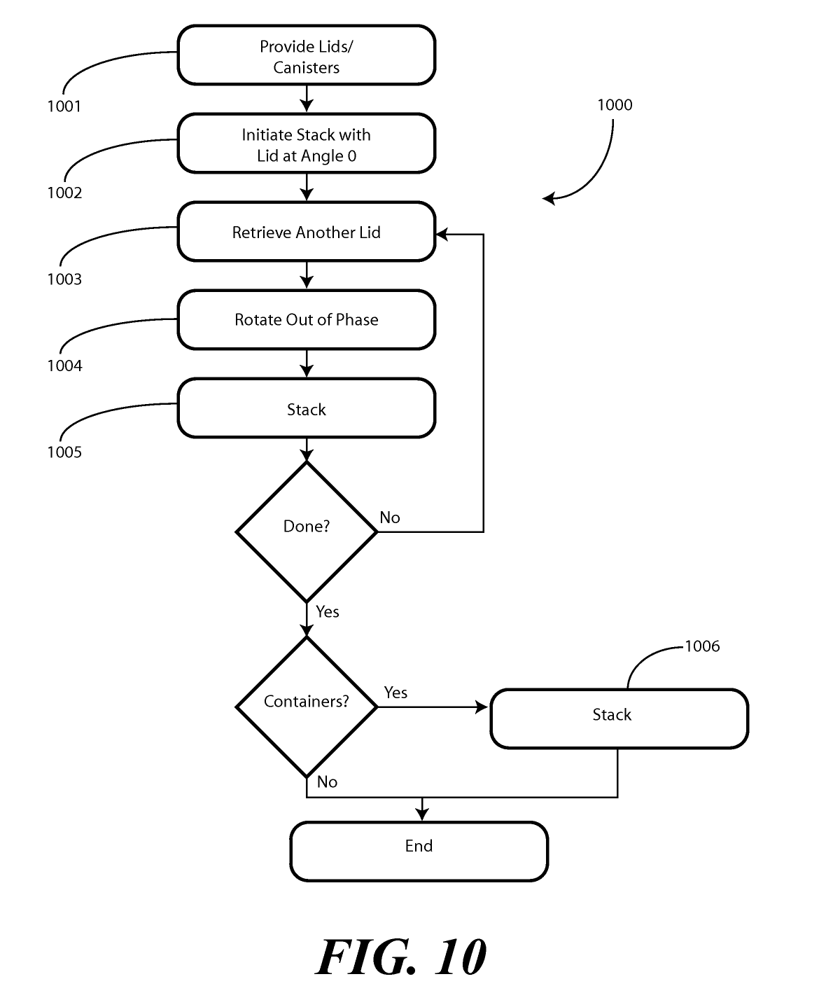

Turning now to FIG. 10, illustrated therein is a method 1000 of stacking lids in accordance with embodiments of the invention. The method 1000 can be accomplished with the assistance of automated equipment, such as automated stacking equipment, industrial robotics, and so forth, to yield a stacked configuration such as that shown in FIG. 9.

At step 1001, the automated stacking machines are provided with a plurality of stackable lids in accordance with embodiments of the invention. These lids may comprises a first partial lid interior portion and a second partial lid interior portion, wherein the first partial lid interior portion includes a plurality of ports extending therefrom and a filter or sleeve engagement extension extending from the bottom of each of the plurality of lids. A filter and/or a filter-protecting sleeve may be coupled to the filter engagement extension at this step 1001. Alternatively, the filter and/or filter protecting sleeve may be coupled to the filter engagement extension prior to this step 1001.

At step 1002, a stack is initiated by the automated stacking equipment by placing a first lid in place. The first lid is placed with an angular rotation of zero. At step 1003, the automated stacking equipment retrieves another lid. At step 1004, the automated stacking equipment rotates the additional lid such that its angular rotation is a predetermined amount, such as 180 degrees, out of phase with the first lid. The additional lid is stacked on the previous lid at step 1005. Where the lids are configured as shown in FIGS. 1-4, this stacking step 1005 results in the filter and/or protective sleeve coupled to the additional lid stacking within the filter receiving recess of the previous lid, as was shown in FIG. 8. The process can then be repeated for the remaining number of lids. Where stacks of canisters are to be shipped with stacks of lids, the canisters can be stacked at step 1006.

The stacking process of FIG. 10 can be used in a variety of configurations. For example, in one embodiment canisters of either 1500 cc capacity or 2400 cc capacity can be stacked and shipped with a plurality of lids. As will frequently be the case, a plurality of cases of canisters and lids are packed and shipped on a shipping pallet. Standard shipping pallets frequently measure forty inches wide by forty-eight inches deep. Embodiments of the present invention have been designed to optimize shipping configurations for such a pallet.

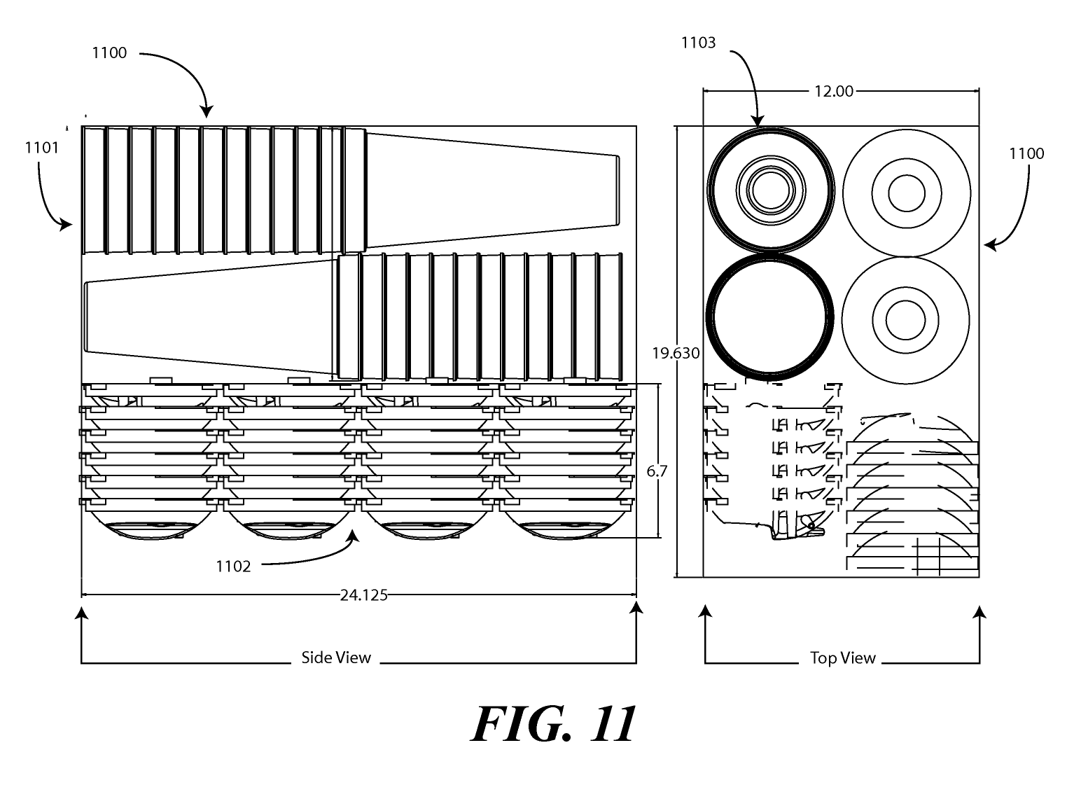

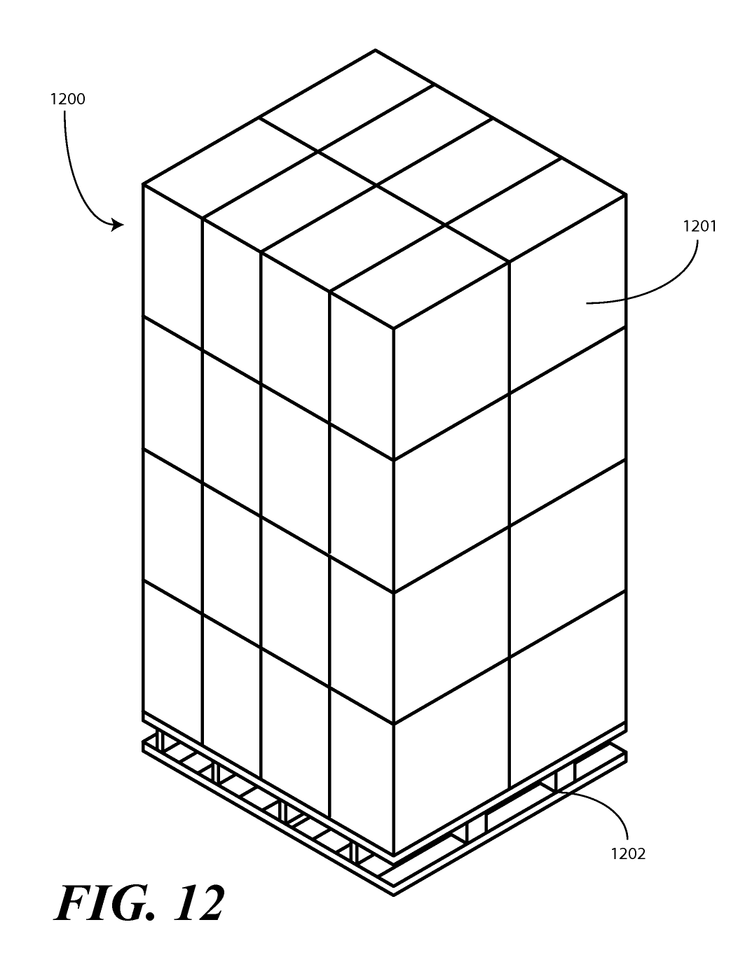

For example, turning now to FIG. 11, illustrated therein is a top view and a side view, labeled accordingly, of an exemplary case stack 1100 that is a result of the method (1000) of FIG. 10. In this illustrative embodiment, each of the canisters 1101 is a 1500 cc canister. The lids 1102 are configured as described with reference to FIGS. 1-3 above.

In accordance with one embodiment of the invention, the canister stacking step (1006) of FIG. 10 comprises stacking canisters in a case that includes at least 48 canisters stacked in one or more stacks. For example, a case can include four stacks 1103 of twelve canisters, as shown in the top view of FIG. 11. These stacks measure between twenty-four and twenty-five inches in height. Similarly, the stacking steps (1001-1005) of FIG. 10 results in stacking at least forty-eight corresponding lids in this case, with the case comprising eight stacks of four lids. Two stacks of canisters and lids measure between nineteen and twenty inches in depth, and approximately twelve inches in width.

When packed in this configuration, thirty-two cases can be conveniently packed on a forty inch by forty-eight inch pallet, as shown in FIG. 12 at 1200. This configuration of cases 1201 perfectly fits on the pallet 1202, and increases the shipping efficiency when compared to prior art canister assemblies. By way of example, prior art canister assemblies with 1500 cc capacity may ship with only ten cases of forty-eight canisters per pallet, due to the larger case size that results from the increased stack heights. With embodiments of the present invention, stacking height can be reduced up to sixty percent. As such, thirty-two cases of forty-eight canisters and lids can be shipped on a single pallet, which results in a two hundred and twenty percent increase in shipping efficiency.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A stackable lid for a fluid collection canister for collecting fluids from fluid collection devices in medical procedures, comprising:
a lid member having an interior portion and a perimeter portion, the interior portion defining a first partial lid interior portion and a second partial lid interior portion, the perimeter portion being configured to connect to the fluid collection canister;
a plurality of ports extending from the first partial lid interior portion, each of the plurality of ports having an axis aligned substantially parallel with a plane defined by the perimeter portion;
an engagement extension extending from a bottom side of the first partial lid interior portion beneath one of the plurality of ports, the engagement extension being configured to connect to one of a filter, a filter-protecting sleeve, or combinations thereof; and
a stacking recess disposed along the second partial lid interior portion, the stacking recess being configured to receive one of another engagement extension of, or an object connected to the another engagement extension, another stackable lid rotated 180 degrees out of phase relative to the stackable lid.

2. The stackable lid of claim 1, wherein the perimeter portion comprises a substantially circular sidewall having one or more compliant coupling members disposed therealong.

3. The stackable lid of claim 1, wherein each of the plurality of ports extend distally from the first partial lid interior portion towards the perimeter portion.

4. The stackable lid of claim 3, wherein each of the plurality of ports has a length extending from the first partial lid interior portion that remains within a perimeter defined by the perimeter portion.

5. The stackable lid of claim 1, wherein every port of the stackable lid is disposed along the first partial lid interior portion.

6. The stackable lid of claim 5, further comprising a pour spout disposed along the second partial lid interior portion.

7. The stackable lid of claim 6, wherein a pour spout axis of the pour spout is oriented substantially orthogonally with axes of each of the plurality of ports.

8. The stackable lid of claim 6, wherein the plurality of ports comprises three ports.

9. The stackable lid of claim 1, wherein the second partial lid interior portion comprises a substantially planar semicircular ledge about the stacking recess.

10. The stackable lid of claim 9, wherein the second partial lid interior portion comprises an arching sidewall extending from the substantially planar semicircular ledge toward the perimeter portion.

11. The stackable lid of claim 1, further comprising a plurality of caps for the plurality of ports, each of the plurality of caps being coupled to the stackable lid by a corresponding tab extending from the perimeter portion along the plane defined by the perimeter portion.

12. The stackable lid of claim 1, wherein the stackable lid comprises a quadrant in the first partial lid interior portion comprising a planar interior member and a port support wall extending substantially orthogonally from the planar interior member.

13. The stackable lid of claim 12, wherein at least two of the plurality of ports extend from the port support wall.

14. A canister assembly, comprising:
a canister base having a bottom and a tapered sidewall extending from the canister base to a lid-engaging rim; and
a lid comprising:
an interior portion surrounded by a canister connector, the interior portion defining a first partial interior portion and a second partial interior portion, wherein the lid comprises a plurality of ports extending from the interior portion, wherein all of the plurality of ports are disposed along the first partial interior portion.

15. The canister assembly of claim 14, wherein the second partial interior portion of the lid comprises a substantially cylindrical recess disposed 180 degrees out of phase relative to one of the plurality of ports.

16. The canister assembly of claim 15, wherein the interior portion comprises a coupling member configured to couple to one of a filter, a protective sleeve, or combinations thereof and extending from a bottom side of the interior portion beneath the one of the plurality of ports.

17. A method of stacking with one or more automated stacking machines, comprising:
providing the one or more automated stacking machines with a plurality of lids, each of the plurality of lids comprising a first partial lid interior portion and a second partial lid interior portion, wherein the first partial lid interior portion comprises a plurality of ports extending therefrom and an engagement extension extending from a bottom of each of the plurality of lids beneath one of the plurality of ports having one of a filter, a filter-protecting sleeve, or combinations thereof coupled thereto, wherein the second partial lid interior portion comprises a receiving recess;
initiating, with the one or more automated stacking machines, a stack with a first lid;
rotating, with the one or more automated stacking machines, a second lid 180 degrees out of phase with the first lid; and
stacking, with the one or more automated stacking machines, the second lid on the first lid such that the one of the filter, the filter-protecting sleeve, or the combinations thereof is coupled to the second lid fits within the receiving recess.

18. The method of claim 17, further comprising stacking, with the one or more automated stacking machines, a plurality of canisters.

19. The method of claim 18, wherein each canister of the plurality of canisters comprises a 1500 cc canister, further comprising placing at one or more canister stacks having at least 48 canisters therein and one or more lid stacks having at least 48 lids therein in a case.

20. The method of claim 19, further comprising stacking 32 cases on a pallet, wherein the pallet has a length of 48 inches and a width of 40 inches.
